(19) United States
(12) Patent Application Publication
(10) Pub. No.: US 2026/0128672 A1
(43) Pub. Date: May 7, 2026

(54) High-Voltage Pulsed Power Generator with Flexible Output Pattern and Voltage Droop Compensation

(71) Applicant: Devesh Malviya, White Plains, NY (US)

(72) Inventor: Devesh Malviya, White Plains, NY (US)

(21) Appl. No.: 19/349,809

(22) Filed: Oct. 3, 2025

(30) Foreign Application Priority Data
Nov. 2, 2024 (IN) 202411083854
Jun. 26, 2025 (IN) 202511061287

(51) Int. Cl. H02M 3/07; A23B 2/00; A23B 2/60; H02M 1/00

(52) U.S. Cl. CPC H02M 3/07; A23B 2/001; A23B 2/003; A23B 2/60; H02M 1/0025

(57) ABSTRACT

The present invention relates to high-voltage solid-state pulsed power generators and discloses a novel topology capable of producing multipulse high-voltage output with enhanced voltage gain using fewer energy storage elements and semiconductor switches, thereby improving system reliability and reducing component count. The architecture provides flexibility in adjusting key pulse parameters such as amplitude, width, and repetition rate, making it suitable for a wide range of applications. The generator features a modular and scalable design, allowing sub-circuits to be added or removed to meet varying load requirements. In addition, the invention discloses a method for compensating voltage droop in long-duration high-voltage pulses without requiring additional power supplies, energy storage devices, switching components, or complex control systems. The proposed method offers selectable levels of compensation, reduces system complexity and footprint, and provides a compact, reliable, and cost-effective solution for voltage droop mitigation in pulsed power applications.

### CROSS REFERENCE TO RELATED APPLICATIONS

This application claims priority under 35 U.S.C. § 119(a) to Indian Patent Application No. 202411083854, filed on Nov. 2, 2024, the entire disclosure of which is hereby incorporated by reference. This application also claims priority under 35 U.S.C. § 119(a) to Indian Patent Application No. 202511061287, filed on Jun. 26, 2025, the entire disclosure of which is hereby incorporated by reference.

Certified copies of the above-identified Indian patent applications will be made available to the United States Patent and Trademark Office (USPTO) via the World Intellectual Property Organization (WIPO) Digital Access Service (DAS).

### FIELD OF THE INVENTION

The present invention relates to the field of power electronics; more particularly, it pertains to high-voltage solid-state pulsed power generators.

The invention focuses on the design of a novel high-voltage pulsed power generator capable of producing multipulse output, and on the development of a method that compensates for voltage droop during pulsed operation while concurrently generating reliable, high-voltage pulses.

### BACKGROUND OF THE INVENTION

Pulsed power generators are utilized across a wide range of applications, including medical technologies, defense systems, and scientific research. One emerging area of application is the food processing industry. Food, being perishable, is susceptible to spoilage and decay due to microbial contamination. Conventional preservation techniques, such as refrigeration, high-temperature pasteurization, and dehydration, often lead to a loss of nutritional value, natural taste, and flavor.

To mitigate these drawbacks, non-thermal pulsed electric field (PEF) treatment has been proposed. This approach has been addressed, for example, in U.S. Pat. No. 5,690,978 and Canadian Patent No. 2,325,691. Various experimental studies have confirmed that applying short-duration, high-voltage pulses can inactivate microorganisms and enzymes responsible for food spoilage. Additionally, it has been shown that PEF treatment preserves food quality.

Subsequent studies indicate that high-voltage multipulse output can further enhance the efficiency of PEF-based sterilization and reduce power consumption. Such multipulse waveforms are typically obtained by superimposing narrow pulses onto wider pulses. While wide pulses may cause continuous electrical breakdown in air, necessitating more robust generator designs, narrow pulses alone may lack sterilization efficacy. The concept of multipulse generation has been introduced to balance these trade-offs and meet the evolving requirements of food processing applications.

Several multipulse generator topologies have been proposed in the literature. In “Analysis and Design of a Soft-Switching Interleaved Forward Converter for Generating Pulsed Electric Fields,” Proc. 25th Int. Telecommun. Energy Conf, pp. 705-712, October 2003, a soft-switching interleaved forward converter with an additional filter inductor is described, resulting in increased bulk and weight. Another approach, disclosed in “Wide Pulse Combined with Narrow-Pulse Generator for Food Sterilization,” IEEE Trans. Ind. Electron., vol. 55, no. 2, pp. 741-748, February 2008, combines a high step-up forward converter, a narrow pulse generator, and a full-bridge inverter. While effective in reducing power consumption, this configuration subjects the inverter switches to full pulse voltage stress, increasing component-level demands.

An alternative design is presented in “High-Voltage Pulsed Power Supply to Generate Wide Pulses Combined with Narrow Pulses,” IEEE Trans. Plasma Sci., vol. 42, no. 7, pp. 1894-1901, July 2014. This system integrates a capacitor-diode voltage multiplier with a resonant circuit, allowing for high-voltage gains by charging capacitors progressively to higher voltages at higher stages. However, the maximum achievable voltage is limited by the ratings of available power electronics switches and passive components.

Outside the food industry, long-duration high-voltage pulses are essential in specialized scientific applications, such as particle accelerators. These systems require high-voltage, unipolar pulses in the range of hundreds of kilovolts with durations spanning hundreds of microseconds to several milliseconds. One such requirement is highlighted in “Long Pulse Modulators,” Proc. CAS-CERN Accelerator School: Power Converters, pp. 217-244, May 2014. A significant challenge in these systems is voltage droop during the output pulse.

Various compensation techniques have been proposed to address this issue. One conventional solution involves the use of a bouncer circuit, as described in “Development of All-Solid-State Bouncer Compensated Long Pulse Modulators for LEP 1 MW Klystrons to be Used for the LINAC4 Project at CERN,” Proc. 14th Linear Accel. Conf, pp. 984-986, October 2008. This method uses passive LC ringing to correct the droop, but results in large and expensive systems with limited adaptability to pulse width and load variations.

European Patent No. EP2856646B1 discloses another approach that uses multiple boost converters connected to modular pulse generator cells. These converters operate to maintain a flat pulse profile. While this architecture improves voltage stability, it introduces complexity and increases the overall system footprint.

A more recent technique, detailed in “A 100 kV, 20 A, 1 ms Long Pulse Solid-State Marx Modulator for Klystron,” Nucl. Instrum. Methods Phys. Res. A, vol. 905, pp. 96-103, October 2018, employs dedicated capacitor banks charged by an auxiliary DC source. These capacitors discharge during the pulse to offset droop. While effective and adjustable, this method requires extra hardware, resulting in a complex and space-consuming design.

Accordingly, there remains a need in the art for a high-voltage pulsed power generator that is modular, scalable, capable of generating multipulse waveforms, and that provides high-voltage gain with reduced component count. Furthermore, there is a need for an integrated voltage droop compensation method that is compact, cost-effective, and does not require separate power supplies or auxiliary circuits. Ideally, the same system should serve both the pulse generation and voltage droop compensation.

### SUMMARY OF THE INVENTION

This summary provides an overview of selected embodiments of the invention, which are further described in detail below. The accompanying figures illustrate example configurations and are not intended to limit the invention's scope.

In one embodiment, a high-voltage pulsed power generation system comprises a direct current (DC) voltage source, a plurality of controllable switches, and a modular architecture including a set of sub-modules and sub-stages. Each sub-module includes one capacitor configured to be sequentially charged from the DC voltage source. Upon completion of the charging cycle, the sub-modules are reconfigured into a series arrangement via controlled actuation of the switching elements, thereby generating an intermediate high-voltage potential. The intermediate voltage is subsequently utilized to charge capacitors within the sub-stages. Following the charging of both sub-module and sub-stage capacitors, these capacitors are discharged in a series configuration to deliver a high-voltage pulse across an output load. The system architecture enables high-voltage gain while minimizing the number of energy storage elements and semiconductor switching devices, thereby enhancing overall system reliability and reducing component complexity. Furthermore, the system provides configurability in pulse shaping, repetition rate, and pulse duration, offering operational flexibility for various application requirements.

In another embodiment, to address microbial contamination of the food, the generator produces multipulse output. This high-voltage output pattern is a combination of wide and narrow high-voltage pulses.

In yet another embodiment, the present disclosure addresses the problem of voltage droop in long-duration high-voltage pulses. The embodiment includes a novel voltage droop compensation method that leverages the same generator circuit elements without requiring additional power sources, switching devices, or passive components. This method enhances the system's compactness, simplicity, and cost-effectiveness.

In the droop compensation mode, the capacitors in the sub-stages are first discharged to deliver the initial high-voltage pulse. As the pulse progresses and droop begins to appear, the sub-module capacitors are sequentially discharged to compensate for the voltage decline. The method further provides precise control over droop mitigation and improves long-pulse performance using the same circuit. Additionally, the compensation method is scalable and allows selectable levels of compensation. The effectiveness of the method increases with the number of sub-modules and sub-stages utilized.

Further features and embodiments will be made apparent by reference to the detailed description and the accompanying drawings.

### BRIEF DESCRIPTION OF THE DRAWINGS

It should be emphasized that the accompanying drawings represent only exemplary embodiments of the present subject matter and are not intended to limit its scope, as the disclosure may encompass other equally effective variations.

FIG. 1 is a schematic diagram of a generalized structure of the disclosed high-voltage pulse generator consisting of x number of sub-modules and y number of sub-stages.

FIG. 2 is a flow chart illustrating the operational logic of the disclosed pulse generator.

FIG. 3(a)-3(f) are equivalent circuit diagrams showing various operating states of the generator, including:
charging of the first sub-module capacitor (FIG. 3(a));
charging of the second sub-module capacitor (FIG. 3(b));
charging of the xth sub-module capacitor (FIG. 3(c));
charging of the sub-stage capacitors (FIG. 3(d));
generation of a high-voltage pulse by discharge of the sub-module and sub-stage capacitors (FIG. 3(e)); and
generation of a widened portion of the multipulse output pattern during a sub-mode of the pulse duration (FIG. 3(f)).

FIG. 4 is a flow chart illustrating an embodiment of the voltage droop compensation method.

FIG. 5 illustrates an equivalent circuit diagram of the pulse generator during the generation of high voltage pulse by the discharge of only sub-stage capacitors.

FIG. 6(a)-6(b) are equivalent circuit diagrams showing first-level (FIG. 6(a)) and second-level (FIG. 6(b)) compensation, respectively.

FIG. 7 is a waveform diagram of the DC voltage source (V_{S}) and the pulsed output voltage (V_{Pulse}) of the generator prototype, consisting of two sub-modules and three sub-stages.

FIG. 8 is a waveform diagram showing the voltages of the sub-module capacitors (V_{CSM1} and V_{CSM2}), the third sub-stage capacitor (V_{CSS3}), and the pulsed output voltage (V_{Pulse}).

FIG. 9 is a waveform diagram of all three sub-stage capacitors (V_{CSS1}, V_{CSS2}, and V_{CSS3}) and the pulsed output voltage (V_{Pulse}).

FIG. 10 is a waveform diagram of the DC voltage source (V_{S}) and a 20 μs wide pulsed output (Vₚᵤₗₛₑ) repeating at 2 kHz.

FIG. 11 is a waveform diagram of the 80 μs wide multipulse output voltage (V_{Pulse}) and the DC voltage source (V_{S}).

FIG. 12 is a waveform diagram of a compensated pulsed output voltage (V_{Pulse}) and the DC voltage source (V_{S}).

FIG. 13 is a waveform diagram providing a zoomed-in view of the compensated pulsed output voltage (V_{Pulse}) and the DC voltage source (V_{S}).

FIG. 14 is a waveform diagram of the DC voltage source (V_{S}), the voltages of the sub-module capacitors (V_{CSM1} and V_{CSM2}), and the first sub-stage capacitor (V_{CSS1}).

FIG. 15 is a waveform diagram of the compensated pulsed output voltage (V_{Pulse}) and the voltages of the three sub-stage capacitors (V_{CSS1}, V_{CSS2}, and V_{CSS3}).

FIG. 16 is a waveform diagram of the DC voltage source (V_{S}) and the pulsed output voltage (V_{Pulse}) during the first-level compensation.

FIG. 17 is a waveform diagram of a three-stage Marx-like high-voltage generator lacking the disclosed voltage droop compensation method.

These and other features of the invention will be apparent from the following detailed description and the appended claims, taken in conjunction with the drawings.

### DETAILED DESCRIPTION OF THE INVENTION

It will be understood by those skilled in the art that various modifications and alterations may be made to the embodiments described herein without departing from the scope of the invention. Well-known functions and structures are not described in detail so as to avoid unnecessarily obscuring the present disclosure.

As used herein, the term “comprises” or “comprising” specifies the presence of the stated features, elements, steps, or components but does not preclude the inclusion or addition of one or more other features, elements, steps, components, or groups thereof. Similarly, the singular forms “a,” “an,” and “the” are intended to include the plural forms as well, unless the context clearly indicates otherwise.

Features described or illustrated in connection with one embodiment may be combined with features of other embodiments, used individually, or substituted for features of other embodiments, unless otherwise specified.

The terminology used herein and in the claims is intended to promote clarity and understanding of the invention and should not be construed as limiting. The embodiments described are provided for illustrative purposes only and are not intended to restrict the scope of the present disclosure. The scope of the invention is defined solely by the appended claims.

Referring now to the drawings, FIG. 1 illustrates a generalized schematic 100 of the high voltage pulse generator comprising x number of sub-modules 130₁, 130₂, . . . , 130ₓ and y number of sub-stages 140₁, 140₂, . . . , 140_{y}, where x and y are positive integers. The generator includes a DC voltage source 110, a main switch 120, a load switch 150, the load 160, and a plurality of sub-modules and sub-stages, wherein each sub-module includes a capacitor (C_{SM}), a limiting resistor (r_{lim.}), and two controllable switches (Tₐ & T_{b}), while each sub-stage includes a capacitor (C_{SS}), a diode (D), and two controllable switches (T_{C} & T_{P}). The main switch 120, load switch 150, and load 160 are also designated as T_{S}, T_{Py+1}, and R, respectively in FIG. 1.

In one embodiment, the sub-module switches are implemented as insulated-gate bipolar transistors (IGBTs) having internal anti-parallel diodes or, alternatively, as metal-oxide-semiconductor field-effect transistors (MOSFETs). Where IGBTs lack internal diodes, external anti-parallel diodes are connected across the respective IGBTs. In contrast, the sub-stage switches are implemented as IGBTs without anti-parallel diodes, or as MOSFETs connected in series with external diodes. Each external diode is oriented such that its cathode is coupled to the drain of the corresponding MOSFET or its anode is coupled to the source of the corresponding MOSFET.

The generator is constructed by connecting a plurality of sub-modules 130₁, 130₂, . . . , 130ₓ in series to form a sub-module chain. This chain is further integrated with a cascaded structure of sub-stages 140₁, 140₂, . . . , 140_{y} arranged in parallel. In one embodiment, a positive terminal of the DC voltage source 110 is connected to a collector of the main switch 120. An emitter of the main switch 120 is further connected to an emitter of switch, T₁ₐ, an anode of diode D₁, and collectors of switches, T_{1b} and T_{P1}. A collector of T₁ₐ is connected to a terminal of capacitor, C_{SM1} through a limiting resistor (rₗᵢₘ.). The other terminal of C_{SM1} is connected to an emitter of T_{1b}, which is further connected to an emitter of T₂ₐ, and a collector of T_{2b}. A collector of T₂ₐ is connected to a terminal of capacitor, C_{SM2} through resistor, rₗᵢₘ., with the other terminal of C_{SM2} being connected to an emitter of T_{2b}. The emitter of T_{2b} is further connected to an emitter of T₃ₐ and a collector of T_{3b}. Additional sub-modules are connected in a similar manner, such that an emitter of the T_{b} switch of the last sub-module (T_{xb}), together with a terminal of its capacitor, is connected to an emitter of the switch, T_{C1}, and ground.

Each sub-stage 140₁, 140₂, . . . , 140_{y} is developed by connecting an anode of a diode (D₁, D₂, . . . , D_{y}) to a collector of a corresponding T_{P} switch (T_{P1}, T_{P2}, . . . , T_{Py}), wherein an emitter of the T_{P} switch is connected to a collector of a corresponding T_{C} switch (T_{C1}, T_{C2}, . . . , T_{Cy}). The collector of the T_{C} switch is further connected to a first terminal of a capacitor (C_{SS1}, C_{SS2}, . . . , C_{SSy}) and a second terminal of the capacitor is connected to the cathode of the diode within the same sub-stage. To interconnect the sub-stages 140₁, 140₂, . . . , 140_{y} in parallel, a cathode of the diode and a collector of the T_{C} switch of a preceding sub-stage are connected to an anode of the diode and an emitter of the T_{C} switch of an immediately succeeding sub-stage, respectively. The cascaded sub-stages are thereby connected to the sub-module chain.

The load switch 150 is connected between a cathode of the diode of the last sub-stage 140_{y} and a first terminal of a resistive load 160, wherein a second terminal of the resistive load 160 is connected to ground.

### A. The High-Voltage Generator

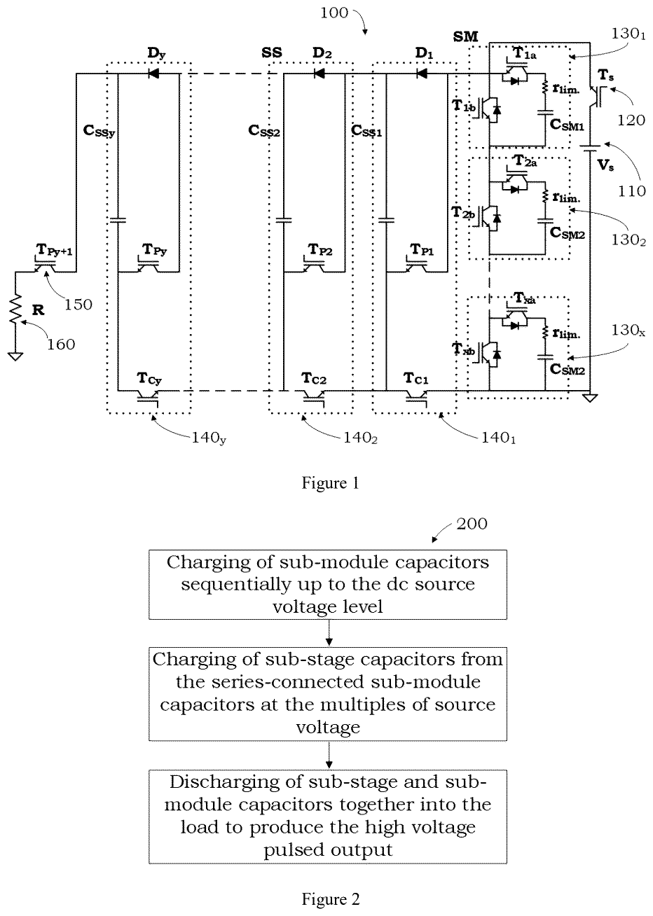

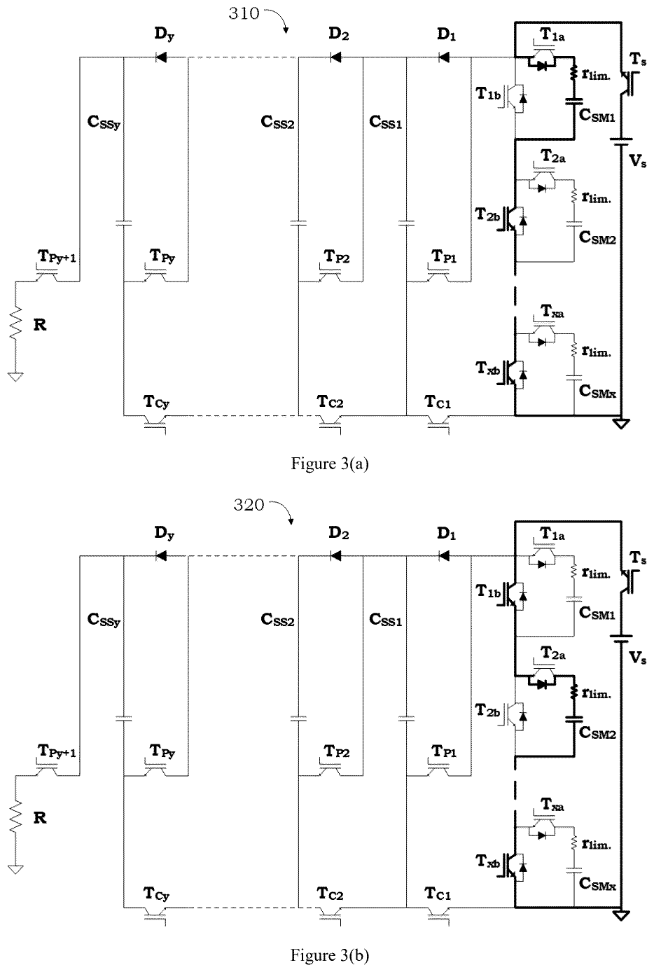

In addition to producing a high-voltage pulse, the generator provides flexibility in adjusting pulse parameters, including amplitude, duration, and repetition rate. The generator further provides a high-voltage gain, thereby reducing the quantity of required semiconductors and passive components, which in turn enhances overall reliability and lowers cost. Moreover, the generator is both modular and readily scalable. The operational principle of the generator is illustrated in the logic flow chart 200 given in FIG. 2. In operation, all sub-module capacitors are sequentially charged to the DC voltage source level (V_{S}), where “sequentially” refers to charging one capacitor after another, such that capacitor C_{SM1} is charged first and capacitor C_{SMx} is charged last. Accordingly,

$${V}_{CSM 1} - {V}_{CSM 2} - ... . - {V}_{CSMx} - {V}_{S} \qquad ( 1 )$$

The equivalent circuits during charging of the sub-module capacitors (C_{SM1}, C_{SM2}, . . . , C_{SMx}) are designated as 310, 320, and 330 as shown in FIGS. 3(a) to 3(c). During this charging sequence, the main switch 120 remains ON, while the Tₐ switches (T₁ₐ, T₂ₐ, . . . , Tₓₐ) remain OFF during the complete charging process of all the sub-module capacitors. The T_{b} switch of the sub-module whose capacitor is getting charged remains OFF during that charging cycle, while the T_{b} switches of all other sub-modules remain ON. Additionally, all T_{C} (T_{C1}, T_{C2}, . . . , T_{Cy}) switches, T_{P} (T_{P1}, T_{P2}, . . . , T_{Py}) switches and the load switch 150 remain OFF. In this sequential charging process, the antiparallel diodes of the Tₐ switches of the sub-modules whose capacitors are getting charged, conduct to complete the electrical paths. In equivalent circuits 310, 320, and 330, the capacitor charging paths are illustrated in bold.

After all the sub-module capacitors are charged to the source voltage level, the sub-stage capacitors (C_{SS1}, C_{SS2}, . . . , C_{SSy}) are charged. In this mode, all T_{P} switches, all T_{b} (T_{1b}, T_{2b}, . . . , T_{xb}) switches, and the load switch 150 remain OFF. The main switch 120, is turned OFF until the next charging of the sub-module capacitors begins in the subsequent switching period. Meanwhile, all Tₐ (T₁ₐ, T₂ₐ, . . . , Tₓₐ) switches and T_{C} switches are turned ON. As a result, the diodes (D₁, D₂, . . . , D_{y}) become forward-biased. Further, the turning ON of Tₐ switches connects all the sub-module capacitors in series, while turning ON the T_{C} switches connects all the sub-stage capacitors in a parallel structure 342 together and with a series-connected chain of sub-module capacitors 341. Consequently, the sub-stage capacitors are charged to the summed voltage of the series-connected sub-module capacitors, as expressed in Equation (2). The corresponding equivalent circuit 340 is shown in FIG. 3(d), with conduction paths indicated in bold.

For the mathematical analysis described herein, the following assumptions are made:
i. All sub-module capacitors are identical (C_{SM1}=C_{SM2}= . . . C_{SMx}=C₁) and lossless.
ii. All sub-stage capacitors are identical (C_{SS1}=C_{SS2}= . . . C_{SSy}=C₂) and lossless.
iii. All switches and diodes are ideal.
iv. The circuit is free from stray resistance, inductance, and capacitance.
v. t_{st.} denotes the time instant at which the pulse duration begins.

$${V}_{CSS 1} = {V}_{CSS 2} = ... . = {V}_{CSSy} = {xV}_{S} \qquad ( 2 )$$

During the charging of the sub-stage capacitors, the voltage across each sub-module capacitor decreases to (1-β)V_{S}, where β represents the per unit dip in the voltage of each sub-module capacitor. Accordingly, Equation (2) is modified as follows:

$${V}_{CSS 1} = {V}_{CSS 2} = ... . = {V}_{CSSy} = ( 1 - β ) {xV}_{S} \qquad ( 3 )$$

After the sub-stage capacitors are charged, all the sub-module capacitors and sub-stage capacitors are connected in series to generate the high voltage pulse discharge on load 160. The discharge path is established by turning ON the load switch 150, all Tₐ and T_{P} switches, while turning OFF all T_{b} and T_{C} switches. The equivalent circuit for this operating mode 350 is shown in FIG. 3(e). For a configuration including x sub-modules and y sub-stages, the magnitude of the output pulse (V_{Pulse}) is expressed by Equation (4):

$${V}_{Pulse} = ( 1 - β ) x ( y + 1 ) {V}_{S} \qquad ( 4 )$$

The pulsed output voltage expression during this mode is provided in Equation (5):

$${V}_{Pulse} ( t ) = ( 1 - β ) x ( y + 1 ) {V}_{S} {e}^{[ \frac{- ( {xC}_{2} + {yC}_{1} ) ( t - {t}_{st .} )}{( R + {xr}_{lim} ) {C}_{1} {C}_{2}} ]} \qquad ( 5 )$$

### 1) Capacitor Design Procedure

The sub-stage capacitors are charged by the sub-module capacitors. Accordingly, the total energy released by the sub-module capacitors during the charging of the sub-stage capacitors is equal to the total energy absorbed by the sub-stage capacitors, as expressed below

$$\frac{{xC}_{1}}{2} ( {V}_{S}^{2} - {V}_{1}^{2} ) = \frac{{yC}_{2}}{2} ( {V}_{2}^{2} - {V}_{3}^{2} ) \qquad ( 6 )$$

In Equation (6), V₁ denotes the voltage across each sub-module capacitor after charging of the sub-stage capacitors, V₂ denotes the voltage across each sub-stage capacitor prior to high voltage pulse generation, and V₃ denotes the voltage across each sub-stage capacitor after high voltage pulse generation. If β represents the per-unit voltage dip of each sub-module capacitor following sub-stage capacitor charging, and γ represents the per-unit voltage dip of each sub-stage capacitor following high-voltage pulse generation. Then, “V₁=(1−β)V_{S}”, “V₂=x(1-β)V_{S}”, and “V₃=x(1−β)(1-γ)V_{S}”. Substituting these expressions in Equation (6) yields the following relationship between C₁ and C₂.

$${C}_{1} = \frac{{xy ( 1 - β )}^{2} [ 1 - {( 1 - γ )}^{2} ]}{[ 1 - {( 1 - β )}^{2} ]} {C}_{2} \qquad ( 7 )$$

Rearrangement of Equation (5) gives

$$\frac{( {xC}_{2} + {yC}_{1} )}{{C}_{1} {C}_{2}} = \frac{( R + {xr}_{lim .} )}{t} \{ ln [ \frac{( 1 - β ) x ( y + 1 ) {V}_{S}}{{V}_{Pulse} ( t )} ] \} \qquad ( 8 )$$

Using Equations (7) and (8), the value of C₁, corresponding to each sub-module capacitor, and C₂, corresponding to each sub-stage capacitor, are determined.

### 2) Multipulse Waveform Generation

This sub-section describes the generation of a multipulse output waveform from the disclosed generator. The multipulse output waveform comprises a combination of wide and narrow high voltage pulses. To generate such pulses, a modification to the pulse discharge mode of the generator is employed, while the remaining operating modes remain unchanged.

In the pulse generation mode, the generator discharges its capacitors in different configurations by adjusting the switching arrangements. To produce a multipulse output pattern, one or more sub-module/sub-stage capacitors are selectively prevented from discharging into the load 160 during a portion of the pulse-width as depicted in FIG. 3(f). The equivalent circuit 360 shown in FIG. 3(f) represents a sub-mode of the pulse generation mode, in which one of the T_{P} switches (herein, T_{P2}) is turned OFF to prevent capacitor C_{SS2} from discharging into load 160. When T_{P2} is turned OFF, diode D₂ becomes forward-biased and completes the pulse discharge path, bypassing C_{SS2}. During this sub-mode, the pulse magnitude is reduced by an amount corresponding to the voltage across C_{SS2}. As a result, the output waveform comprises a wide and a narrow high-voltage pulse. By appropriately selecting which capacitors are allowed or prevented from discharging at different portions of the pulse-width, various multipulse output patterns are achieved.

### B. Voltage Droop Compensation Method

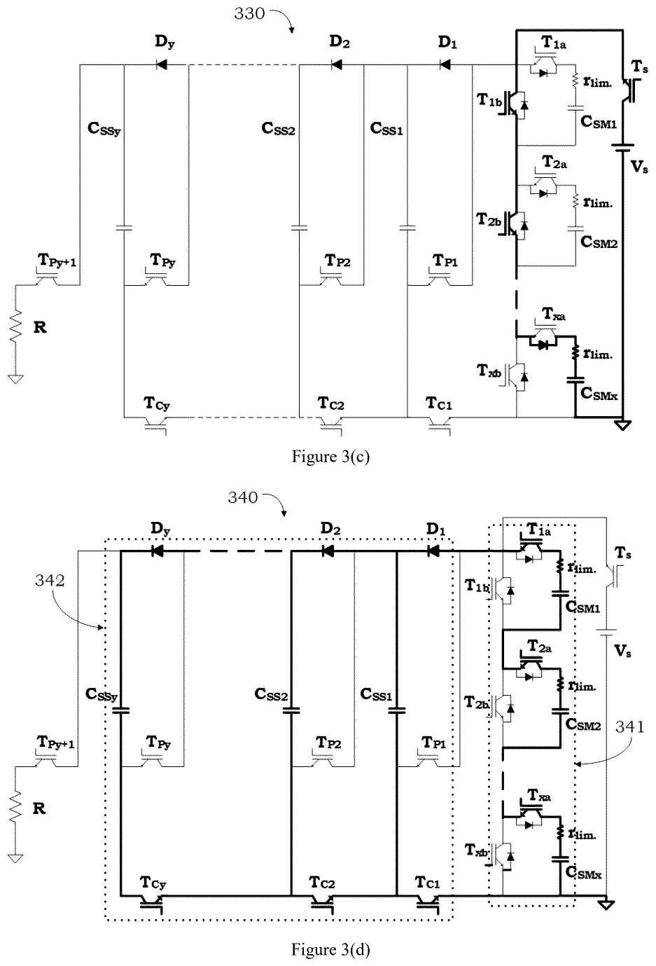

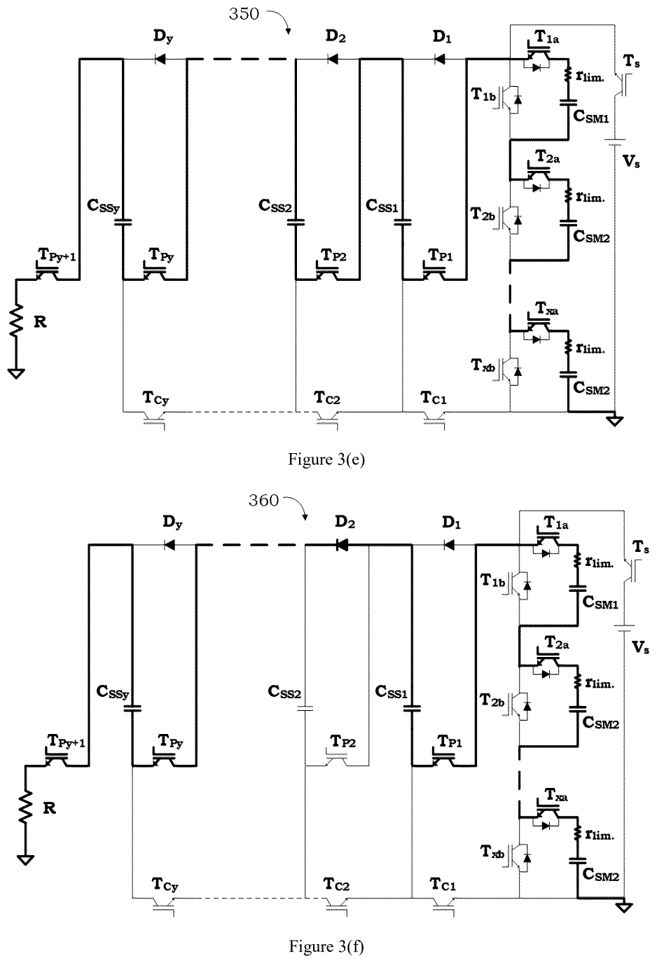

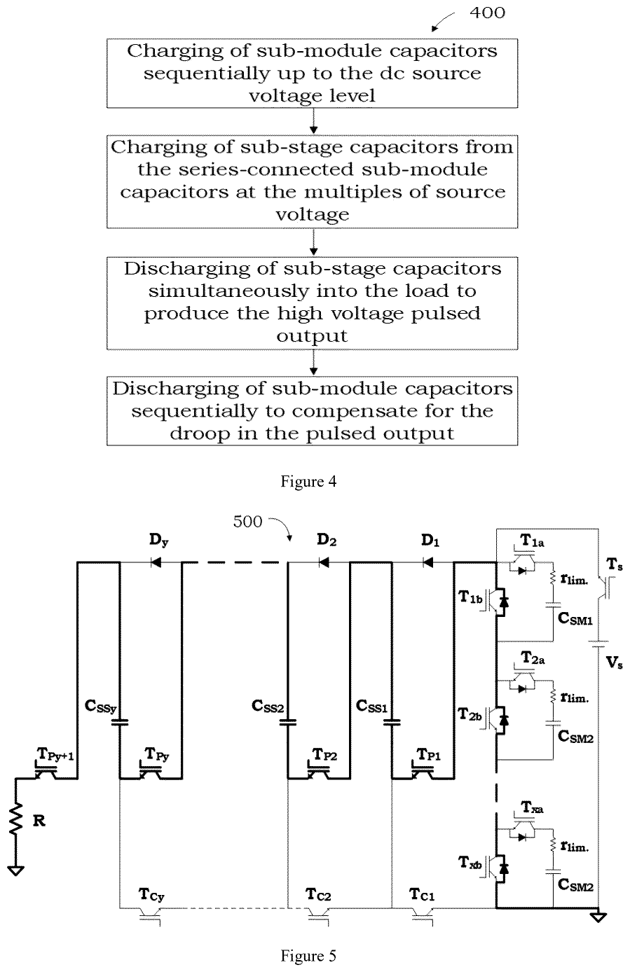

FIG. 4 illustrates a flow chart 400 of a voltage droop compensation method in accordance with the principles of the present disclosure. This method is implemented on the same generator described in section A and enables the generator to compensate the voltage droop in the pulsed output. Unlike the control logic 200 illustrated in FIG. 2, which employs both the sub-module capacitors and the sub-stage capacitors for high-voltage pulse generation, the disclosed method utilizes only the sub-stage capacitors for pulse generation. In addition, the method permits selectable levels of compensation.

The operating principle of the method differs during the pulse discharge process. After the sub-stage capacitors are charged to a steady-state voltage level, as described in Equation (3), all Tₐ, T_{b}, and T_{C} switches are turned OFF, while all T_{P} switches are turned ON together with the load switch 150. The main switch 120 also remains OFF. The equivalent circuit 500 corresponding to this mode is illustrated in FIG. 5, wherein the conduction paths are highlighted in bold. In this arrangement, all sub-stage capacitors are connected in series with the load 160, thereby generating a high-voltage pulse across it. The magnitude of the pulse is given by (1−β)xyV_{S}, and the pulsed voltage expression in the time domain is provided in Equation (9).

$${V}_{Pulse} ( t ) = ( 1 - β ) {xyV}_{S} {e}^{[ \frac{- y ( t - {t}_{st .} )}{{RC}_{2}} ]} \qquad ( 9 )$$

Referring to Equation (9), it is observed that an increase in pulse width results in an increased voltage droop. To compensate for the voltage droop, a method is employed in which the sub-module capacitors are sequentially discharged into the load 160 whenever the voltage droop becomes greater than or equal to the holding voltage of a sub-module capacitor, i.e., (1−β)V_{S}. The method achieves compensation by permitting some or all of the sub-module capacitors to discharge into the load 160. For instance, if two of the total x sub-module capacitors are discharged for compensation, the compensation level is two, whereas if all x sub-module capacitors are discharged, the compensation level is x.

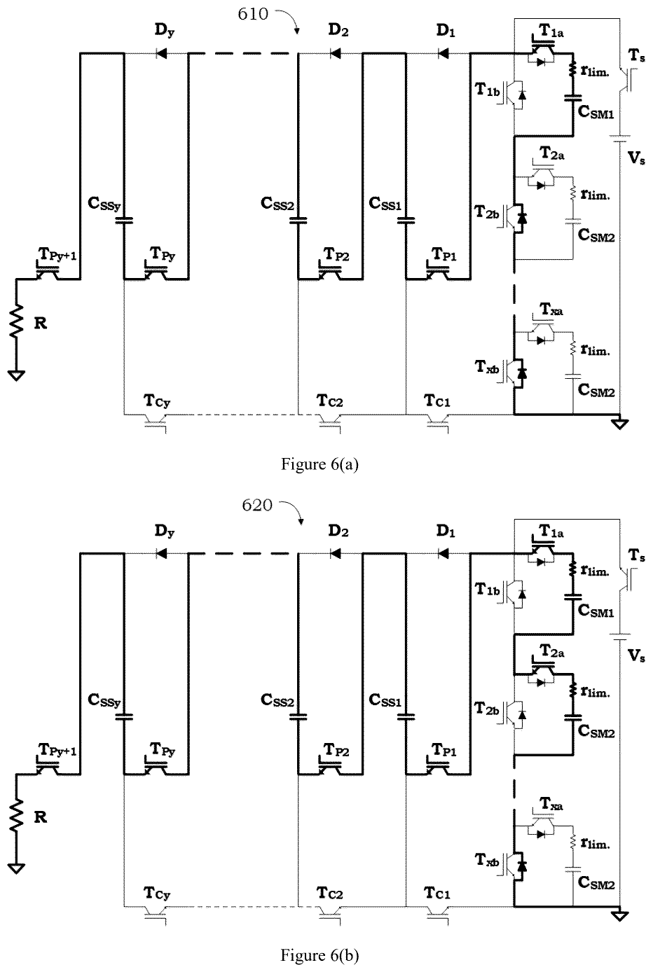

Equivalent circuits 610, 620, 350 corresponding to the first, second, and xl levels of droop compensation are presented in FIGS. 6(a), 6(b), and 3(e), respectively. During these compensation modes, all T_{P} switches remain ON along with the load switch 150, while all T_{C} and T_{b} switches remain OFF. The Tₐ switches are selectively turned ON when their respective sub-module capacitors contribute toward voltage droop compensation. For example, during the first level of compensation, switch T₁ₐ is turned ON, thereby discharging capacitor C_{SM1} into the load in combination with the sub-stage capacitors. At the second level of compensation, switch T₂ₐ is turned ON, while the rest of the switching configuration remains unchanged. This causes capacitor C_{SM2} to discharge into the load along with C_{SM1} and the sub-stage capacitors. At the x^{th} level of compensation, as illustrated in FIG. 3(e), all Tₐ switches conduct, thereby discharging their respective sub-module capacitors into the load. The conduction paths in these equivalent circuits 610, 620, 350 are highlighted in bold. A detailed time-domain analysis of the voltage droop compensation method is set forth below.

At the instant corresponding to the start of the pulsed output, t_{st.}, the magnitude of the pulsed output is given by:

$${V}_{Pulse} ( {t}_{st .} ) = ( 1 - β ) {xyV}_{S} \qquad ( 10 )$$

During the pulse discharge, at any instant of time, t_{1′}, the magnitude of the pulsed output is given as

$${V}_{Pulse} ( {t}_{{1}^{′}} ) = ( 1 - β ) {xyV}_{S} {e}^{[ \frac{- y ( {t}_{{1}^{′}} - {t}_{st .} )}{{RC}_{2}} ]} \qquad ( 11 )$$

The pulsed output magnitude obtained using Equation (11) is less than that calculated using Equation (10), and if the condition provided in Equation (12) is satisfied, the Tₐ switch of the first sub-module is turned ON. This switching arrangement causes C_{SM1} to discharge into load 160 along with the sub-stage capacitors. As a result, the pulse magnitude increases instantaneously (neglecting circuit parasitics and the rise time of the switch), and the resulting pulsed output magnitude is expressed in Equation (13).

$${V}_{Pulse} ( {t}_{st .} ) - {V}_{Pulse} ( {t}_{{1}^{′}} ) \geq ( 1 - β ) {V}_{S} \qquad ( 12 )$$

$${V}_{Pulse} ( {t}_{{1}^{′}} ) {\vert}_{compensated} = ( 1 - β ) {xyV}_{S} {e}^{[ \frac{- y ( {t}_{{1}^{′}} - {t}_{st .} )}{{RC}_{2}} ]} + ( 1 - β ) {V}_{S} \qquad ( 13 )$$

Since after t_{1′}, capacitor C_{SM1} also discharges along with the sub-stage capacitors, the pulsed output voltage expression is derived as shown in Equation (14).

$${V}_{Pulse} ( t ) = {V}_{Pulse} ( {t}_{{1}^{′}} ) {\vert}_{compensated} {e}^{- ( t - {t}_{{1}^{′}} ) [ \frac{{C}_{2} + {yC}_{1}}{( R + {r}_{lim .} ) {C}_{1} {C}_{2}} ]} \qquad ( 14 )$$

Herein, all sub-module capacitors have the same capacitance, i.e., C_{SM1}=C_{SM2}= . . . =C_{SMx.}=C₁. Equation (14) indicates that, over time, the magnitude of the pulsed output decreases. At another instant, t_{2′}, when the droop becomes greater than or equal to (1−β)V_{S}, switch T₂ₐ is turned ON. This causes capacitor C_{SM2}, along with capacitor Cs_{M1} and all sub-stage capacitors, to discharge into load 160. The compensated pulsed output at time, t_{2′} has the magnitude given in Equation (15), and the pulsed output voltage expression after t_{2′} is provided in Equation (16).

$${V}_{Pulse} ( {t}_{{2}^{′}} ) {\vert}_{compensated} = {V}_{Pulse} ( {t}_{{1}^{′}} ) {\vert}_{compensated} {e}^{- ( {t}_{{2}^{′}} - {t}_{{1}^{′}} ) [ \frac{{C}_{2} + {yC}_{1}}{( R + {r}_{lim .} ) {C}_{1} {C}_{2}} ]} + ( 1 - β ) {V}_{S} \qquad ( 15 )$$

$${V}_{Pulse} ( t ) = {V}_{Pulse} ( {t}_{{2}^{′}} ) {\vert}_{compensated} {e}^{- ( t - {t}_{{2}^{′}} ) [ \frac{2 {C}_{2} + {yC}_{1}}{( R + 2 {r}_{lim .} ) {C}_{1} {C}_{2}} ]} \qquad ( 16 )$$

Similarly, at time t_{x′}, the last sub-module capacitor, C_{SMx} begins discharging to compensate for the voltage droop in the pulsed output. The compensated voltage at t_{x′} is given in Equation (17), and the pulsed output voltage expression for the remaining pulse duration is provided in Equation (18).

$${V}_{Pulse} ( {t}_{{x}^{′}} ) {\vert}_{compensated} = {V}_{Pulse} ( {t}_{x - {1}^{′}} ) {\vert}_{compensated} {e}^{- ( {t}_{{x}^{′}} - {t}_{x - {1}^{′}} ) \{ \frac{( x - 1 ) {C}_{2} + {yC}_{1}}{[ R + ( x - 1 ) {r}_{lim .} ] {C}_{1} {C}_{2}} \}} + ( 1 - β ) {V}_{S} \qquad ( 17 )$$

$${V}_{Pulse} ( t ) = {V}_{Pulse} ( {t}_{{x}^{′}} ) {\vert}_{compensated} {e}^{- ( t - {t}_{{x}^{′}} ) [ \frac{{xC}_{2} + {yC}_{1}}{( R + {xr}_{lim .} ) {C}_{1} {C}_{2}} ]} \qquad ( 18 )$$

In this manner, the proposed method compensates for voltage droop during the pulse duration. Moreover, this method becomes increasingly effective as the number of sub-modules 130₁, 130₂, . . . , 130ₓ and sub-stages 140₁, 140₂, . . . , 140_{y} increases. In some embodiments, an intelligent feedback loop may be integrated with the disclosed system. The feedback loop continuously monitors the pulsed output, and when the droop exceeds (1−β)V_{S}, it triggers the corresponding Tₐ switches to sequentially discharge the sub-module capacitors into the load 160. Consequently, the pulsed output voltage droop is actively compensated in real time via automated control of the Tₐ switches' ON and OFF states.

### C. Experimental Results

An experimental validation of the disclosed generator was conducted, with the design parameters summarized in Table I.

TABLE 1
Experimental parameters for the generator prototype.

| Parameters | Value/ Part no. | | Parameters | Value/ Part no. |
|---|---|---|---|---|
| DC voltage source level (V_{S}) | 150 | V | Sub-module capacitor values | 6 μF |
| Pulsed output magnitude (V_{Pulse}) | 1.2 | kV | Sub-stage capacitor values | 1 μF |
| Pulse rate | 1 kHz-2 kHz | | Diodes | DSEI 12-10A |
| Pulse size | 20 μs-50 μs | | Gate driver IC | HCPL 3180 |
| Load resistor value | 5 | kΩ | Micro-controller | dsPIC 30F6014A |

| | | | |
|---|---|---|---|
| Sub-module switches | IKW15T120 | Sub-stage switches | IGW15T120 |

For the specified values of DC voltage source level, V_{S}=150 V and a desired pulsed output magnitude (V_{Pulse}) of 1.2 kV, the required number of sub-modules (x) and sub-stages (y) were determined using the relationship, V_{Pulse}=x(y+1)V_{S}. Based on this expression, two possible configurations satisfy the design requirements, namely, x=4 with y=1, and x=2 with y=3. Considering factors such as device voltage stress, component count, and pulse repetition rate, a prototype incorporating two sub-modules (SM1, SM2) and three sub-stages (SS1, SS2, SS3) was constructed as the preferred embodiment for experimental verification.

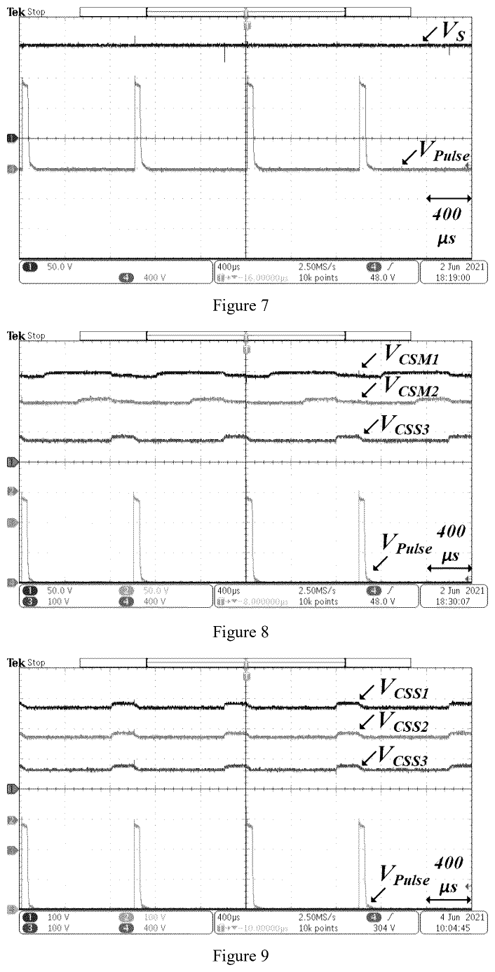

The experimental results are summarized as follows. FIG. 7 shows 50 μs wide high-voltage pulses (V_{Pulse}) at a repetition rate of 1 kHz, together with the DC voltage source waveform (V_{S}). The measured pulsed output magnitude is approximately 1.12 kV, which is slightly lower than the theoretical amplitude predicted by Equation (4), primarily due to non-idealities in the experimental setup. The corresponding voltage waveforms of the sub-module capacitors (V_{CSM1}, V_{CSM2}) and sub-stage capacitors (V_{CSS1}, V_{CSS2}, V_{CSS3}), together with the pulsed output (V_{Pulse}), are shown in FIG. 8 and FIG. 9, respectively. These results are in line with the analytical predictions.

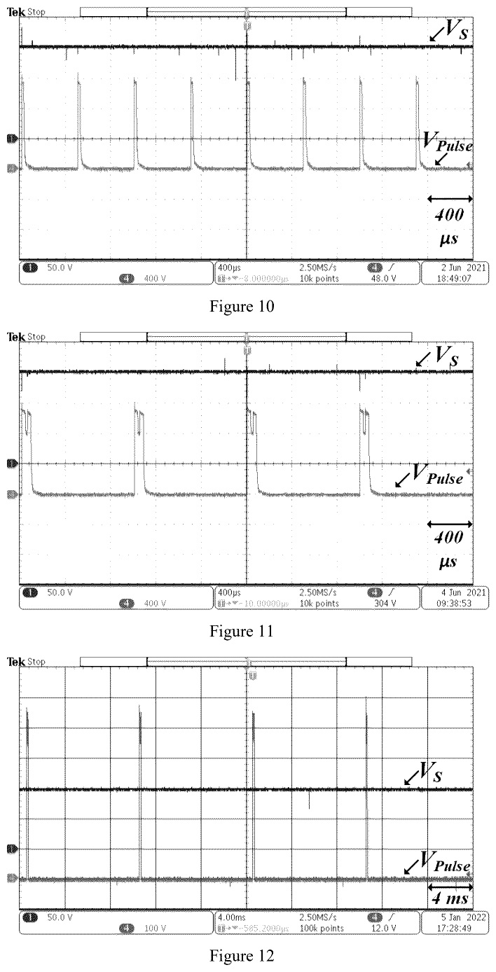

To further demonstrate the capability of the disclosed generator to produce pulses with variable widths and repetition rates, FIG. 10 illustrates high-voltage pulses (V_{Pulse}) of 20 μs width repeating at 2000 pulses per second along with the DC voltage source waveform (V_{S}). In addition, FIG. 11 presents the DC voltage source waveform (V_{S}) along with the multipulse output pattern (V_{Pulse}) in which each sequence comprises two 30 μs pulses separated by a 20 μs pulse.

TABLE 2
Experimental parameters for the generator prototype
demonstrating pulsed voltage droop compensation

| Parameters | Value/ Part no. | | Parameters | Value/ Part no. |
|---|---|---|---|---|
| DC voltage source level (V_{S}) | 100 | V | Sub-module capacitor values | 100 μF |
| Pulse rate | 100 | Hz | Sub-stage capacitor values | 1 μF |
| Pulse size | 150 | μs | Diodes | DSEI 12-10A |
| Load resistor value | 1 | kΩ | Sub-module switches | IKW15T120 |

| | | | |
|---|---|---|---|
| No. of sub-modules | 2 | Sub-stage switches | IGW15T120 |
| No. of sub-stages | 3 | | |

Further, to validate the disclosed voltage droop compensation method, the same generator prototype comprising two sub-modules (SM1, SM2) and three sub-stages (SS1, SS2, SS3) was constructed in accordance with the parameters summarized in Table II. For a permissible pulsed voltage droop of 40% over a pulse duration of 150 μs and a permissible per unit dip (β) of 0.02 in the holding voltage of the sub-module capacitors, the value of the sub-stage capacitor (C₂) was calculated as 0.92 μF using Equation (11). For practical implementation, commercially available capacitors having a capacitance of 1 μF were selected for the sub-stage capacitors. With this selected value, the pulsed voltage droop was improved to approximately 37.5%. Accordingly, for a pulsed voltage droop of 37.5%, β of 0.02, and C₂ of 1 μF, the sub-module capacitor value (C₁) was calculated as 88.67 μF using Equation (7). For the prototype, commercially available capacitors with a capacitance of 100 μF were employed as the sub-module capacitors.

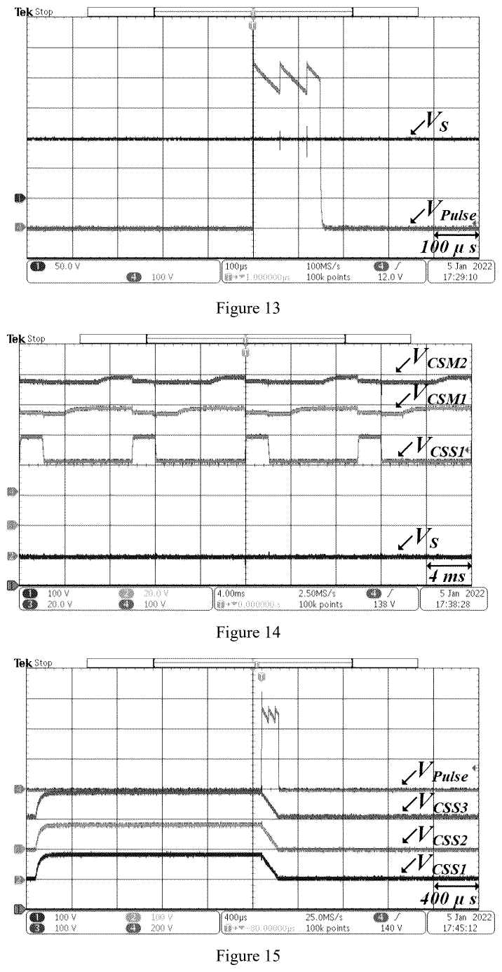

The experimental results are summarized as follows. FIG. 12 illustrates the DC source voltage waveform (V_{S}) with respect to the pulsed output (V_{Pulse}). As shown, the waveform demonstrates 150 μs duration pulses of amplitude around 560 V repeating at a rate of 100 pulses per second. The amplitude of the pulses is observed to be slightly lower than the calculated value, which may be attributed to non-idealities inherent in the circuit. A magnified view of the output pulse (V_{Pulse}) along with the DC voltage source waveform (V_{S}) is provided in FIG. 13, wherein the effect of the disclosed compensation method is clearly depicted. In the illustrated embodiment, two sub-module capacitors are employed for voltage droop compensation. As such, the voltage droop is compensated in two stages, first by the capacitor C_{SM1} and subsequently by the capacitor C_{SM2}. From the waveform, it is observed that the uncompensated voltage droop, expected to be approximately 37.5% by the end of the pulse, is reduced to about 12.5%. The maximum droop occurring just prior to the commencement of compensation by C_{SM2} is measured at approximately 19.6%, which is still nearly half of the uncompensated droop value.

FIG. 14 illustrates the voltage waveforms of both sub-module capacitors (V_{CSM1} and V_{CSM2}) and the first sub-stage capacitor (V_{CSS1}), in conjunction with the DC voltage source waveform (V_{S}). The waveform demonstrates that the sub-module capacitors are sequentially charged to the source voltage level and subsequently discharged to (1−β)V_{S} while simultaneously charging the sub-stage capacitors. The first sub-stage capacitor, C_{SS1}, is thereby charged to nearly twice the value of (1−β)V_{S}. However, due to non-idealities in the experimental configuration, the per-unit dip (β), theoretically expected to be approximately 0.02, is experimentally observed to be slightly above 0.06. The voltage waveforms of all sub-stage capacitors (V_{CSS1}, V_{CSS2}, V_{CSS3}) are further presented in FIG. 15 along with the pulsed output (V_{Pulse}), thereby confirming that all sub-stage capacitors are charged and discharged uniformly, and thus contribute equally to the pulse discharge.

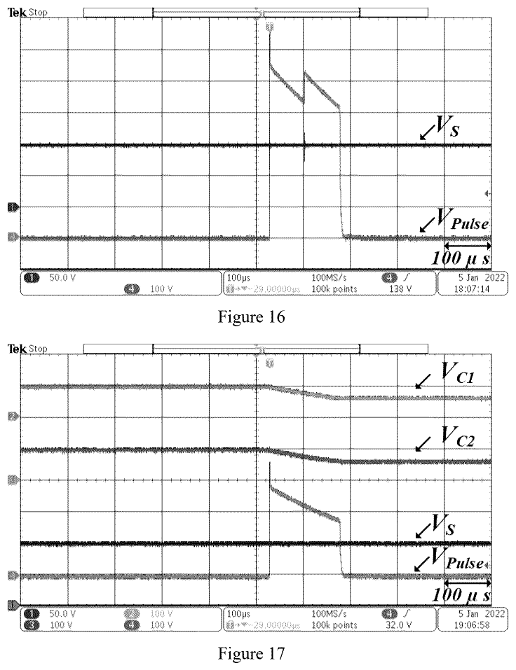

To further demonstrate the flexibility of the disclosed method, an experimental configuration was tested wherein only a single sub-module capacitor (C_{SM1}) was employed for droop compensation. The corresponding results are depicted in FIG. 16, which shows the DC voltage source waveform (V_{S}) along with the pulsed output (V_{Pulse}). Under this configuration, the pulsed output exhibited a larger voltage droop of approximately 25% over the entire pulse duration. While this droop is greater than that obtained using two sub-module capacitors, it is still significantly reduced in comparison to the droop observed in the absence of the compensation method.

For comparative evaluation, a conventional three-stage Marx-type circuit was also constructed and tested under the same design specifications, without the application of the disclosed compensation method. The corresponding experimental outcome is presented in FIG. 17, which shows the waveforms of the source voltage (V_{S}), the pulsed output voltage (V_{Pulse}), and the voltage waveforms of two capacitors (V_{C1} and V_{C2}) of the three-stage configuration. As illustrated, both capacitors were equally charged to the DC voltage source level and discharged simultaneously to produce a pulse of amplitude approximately equal to three times the DC voltage source. However, the uncompensated pulsed output exhibited a voltage droop of approximately 36%. Accordingly, a comparison of the experimental results validates the effectiveness of the disclosed voltage droop compensation method in significantly reducing the voltage droop.

1. A high voltage solid-state pulsed power generator, comprising:
a DC voltage source, a main switch (T_{S}), a load switch (T_{Py+1}), and a plurality of sub-modules and sub-stages, wherein each sub-module comprises a capacitor (C_{SM}), a limiting resistor (r_{lim.}), and two controllable switches (Tₐ & T_{b}), and each sub-stage comprises a capacitor (C_{SS}), a diode (D), and two controllable switches (T_{C} & T_{P}).

2. The generator of claim 1, wherein the plurality of sub-modules are connected in series to form a sub-module chain, the sub-module chain being connected in parallel with a cascaded structure of sub-stages connected in parallel, wherein:
(a) a positive terminal of the DC voltage source is connected to a collector of the main switch (T_{S}), an emitter of T_{S} is connected to an emitter of switch, T₁ₐ, an anode of diode D₁, and collectors of switches, T_{1b} and T_{P1};
(b) a collector of T₁ₐ is connected to a terminal of capacitor, C_{SM1} through resistor, r_{lim.}, the other terminal of C_{SM1} being connected to an emitter of T_{1b}, which is further connected to an emitter of T₂ₐ and a collector of T_{2b};
(c) a collector of T₂ₐ is connected to a terminal of capacitor, C_{SM2} through resistor, r_{lim.}, the other terminal of C_{SM2} being connected to an emitter of T_{2b}, which is further connected to an emitter of T₃ₐ and a collector of T_{3b};
(d) additional sub-modules are similarly connected, such that an emitter of the T_{b} switch of the last sub-module (T_{xb}) and a terminal of its capacitor are connected to an emitter of T_{C1}, negative terminal of the DC voltage source, and ground;
(e) a plurality of sub-stages is connected in parallel such that a cathode of a diode and a collector of a T_{C} switch of a preceding sub-stage are connected to an anode of a diode and an emitter of a T_{C} switch of an immediately succeeding sub-stage, respectively, and the cascaded sub-stages are further connected to the sub-module chain;
(f) a load switch (T_{Py+1}) is connected between a cathode of the diode of a last sub-stage and a resistive load (R), the other terminal of the load being connected to the ground.

3. The generator of claim 1, wherein the sub-module capacitors (C_{SM1}, C_{SM2}, . . . , C_{SMx}) are sequentially charged to the DC voltage source level (V_{S}), and thereafter connected in series to charge the sub-stage capacitors (C_{SS1}, C_{SS2}, . . . , C_{SSy}) through the Tₐ switches of the sub-modules, the diodes of the sub-stages, and the T_{C} switches of the sub-stages.

4. The generator of claim 1, wherein the sub-stage capacitors are charged to an enhanced voltage level up to a maximum of xV_{S}, where x is the Number of Sub-Modules, and Wherein one or more sub-modules may be bypassed by turning OFF the corresponding Tₐ switch, such that the charging path is completed through an anti-parallel diode of the T_{b} switch of the bypassed sub-module.

5. The generator of claim 1, wherein a high-voltage pulse is generated by discharging the sub-module capacitors and the sub-stage capacitors in series into the load, the discharge path including all sub-module capacitors (C_{SM1}, C_{SM2}, . . . , C_{SMx}), sub-stage capacitors (C_{SS1}, C_{SS2}, . . . , C_{SSy}), Tₐ switches (T₁ₐ, T₂ₐ, . . . , Tₓₐ), T_{P} switches (T_{P1}, T_{P2}, . . . , T_{Py}), the load switch (T_{Py+1}), and the load (R), thereby generating a pulse magnitude of x(y+1)V_{S}, where x and y are the number of sub-modules and sub-stages, respectively.

6. The generator of claim 1, wherein the output comprises a unipolar pulse with or without multiple sub-pulses within a single high-voltage pulse.

7. The generator of claim 1, wherein a multipulse output is generated by selectively preventing one or more sub-stage capacitors from discharging into the load during a portion of the pulse width by turning OFF the corresponding T_{P} switch, thereby forward-biasing the corresponding diode to bypass the sub-stage capacitor and reducing the pulse magnitude by the capacitor's stored voltage.

8. The generator of claim 1, wherein a multipulse output is generated by selectively preventing one or more sub-module capacitors from discharging into the load during a portion of the pulse width by turning OFF the corresponding Tₐ switch, thereby forward-biasing the anti-parallel diode of the corresponding T_{b} switch to bypass the sub-module capacitor and reducing the pulse magnitude by the capacitor's stored voltage.

9. The generator of claim 1, wherein the pulse magnitude, width, and repetition rate are adjustable by controlling the discharge of stored energy from the capacitors through the controllable switches.

10. The generator of claim 1, wherein:
the sub-module switches comprise insulated-gate bipolar transistors (IGBTs) with internal anti-parallel diodes or metal-oxide-semiconductor field-effect transistors (MOSFETs), and wherein, if IGBTs lack internal diodes, external anti-parallel diodes are connected across them; and the sub-stage switches comprise IGBTs without anti-parallel diodes, or MOSFETs each connected in series with an external diode, the external diode being connected such that a cathode of the diode is connected to a drain of the MOSFET or an anode of the diode is connected to a source of the MOSFET.

11. A method of operating the generator of claim 1 to compensate for pulsed voltage droop, comprising employing the same pulse generator circuit elements to generate the high-voltage pulse and to perform voltage-droop compensation.

12. The method of claim 11, wherein the high-voltage pulse is generated by discharging all sub-stage capacitors (C_{SS1}, C_{SS2}, . . . C_{SSy}) in series into the load by turning ON all T_{P} switches (T_{P1}, T_{P2}, . . . , T_{Py}), and the load switch, T_{Py+1} with all other switches OFF, thereby producing an output magnitude of xyV_{S}.

13. The method of claim 11, wherein during pulse generation:
(a) a collector of T_{1b} is connected to a collector of T_{P1}, whose emitter is connected to one terminal of C_{SS1};
(b) another terminal of C_{SS1} is connected to a collector of T_{P2}, whose emitter is connected to one terminal of C_{SS2};
(c) subsequent sub-stage capacitors (C_{SS3} . . . C_{SSy}) are similarly connected in series through their corresponding T_{P} switches; and
(d) the second terminal of the capacitor of the last sub-stage (C_{SSy}) is connected to the collector of the load switch, T_{Py+1};
(e) an emitter of T_{Py+1} is connected to one terminal of load R, the other terminal of load R being connected through anti-parallel diodes of the T_{b} (T_{1b}, T_{2b}, . . . , T_{xb}) switches, such that the pulse discharge path is completed while all the Tₐ (T₁ₐ, T₂ₐ, . . . , Tₓₐ), T_{b} (T_{1b}, T_{2b}, . . . , T_{xb}), T_{C} (T_{C1}, T_{C2}, . . . , T_{Cy}) switches and the main switch, T_{S} remain OFF.

14. The method of claim 11, wherein voltage-droop compensation is achieved by discharging the sub-module capacitors (C_{SM1}, C_{SM2}, . . . , C_{SMx}) into the load sequentially during pulse generation, thereby compensating for voltage droop, the compensation effectiveness being enhanced with a greater number of sub-modules and sub-stages.

15. The method of claim 11, further comprising an intelligent feedback loop configured to monitor the pulsed output and control ON and OFF times of the Tₐ switches to automatically compensate for voltage droop.

16. The electrical connection formed during pulsed voltage droop compensation as claimed in claim 11, wherein the electrical path dynamically changes multiple times during pulse generation, the number of such changes being equal to the selected level of compensation, such that:
(a) at a first level of compensation, a sub-module capacitor (C_{SM1}) discharges into the load, R through its corresponding Tₐ switch while bypassing the anti-parallel diode of its associated T_{b} switch;
(b) at subsequent levels of compensation, additional sub-module capacitors (C_{SM2} . . . C_{SMx}) sequentially discharge into the load, R through their respective Tₐ switches while bypassing the anti-parallel diodes of their respective T_{b} switches; and
(c) when only a subset of the total x sub-module capacitors is discharged, the compensation level corresponds to the number of capacitors engaged, whereas when all sub-module capacitors are discharged, the compensation level equals x.
